(19) United States
(12) Patent Application Publication
(10) Pub. No.: US 2006/0141277 A1
(43) Pub. Date: Jun. 29, 2006

(54) Multi-layer products, production method thereof and use of same

(76) Inventors: Luc Forget, Lentzweiler (LU); Alexandre Siche, Wiltz (LU)

Correspondence Address: CANTOR COLBURN, LLP, 55 GRIFFIN ROAD SOUTH, BLOOMFIELD, CT, 06002, US

(21) Appl. No.: 10/535,088

(22) PCT Filed: Oct. 1, 2003
(86) PCT No.: PCT/EP03/50676

§ 371 Date: Oct. 5, 2005

(30) Foreign Application Priority Data
Dec. 2, 2002 (EP) 02292967.3

(51) Int. Cl. B32B 27/32; B32B 27/08

(52) U.S. Cl. 428/516; 428/523; 264/540; 264/160; 156/60

(57) ABSTRACT

The invention relates to multi-layer products comprising a polymer substrate (1), a wearing layer (2) which is made from an ionemer-type polymer and an intermediary layer (3) which is made from an olefin polymer containing a metallocene. The invention also relates to a method of producing one such product and to the use of said multilayer products for the production of flooring.

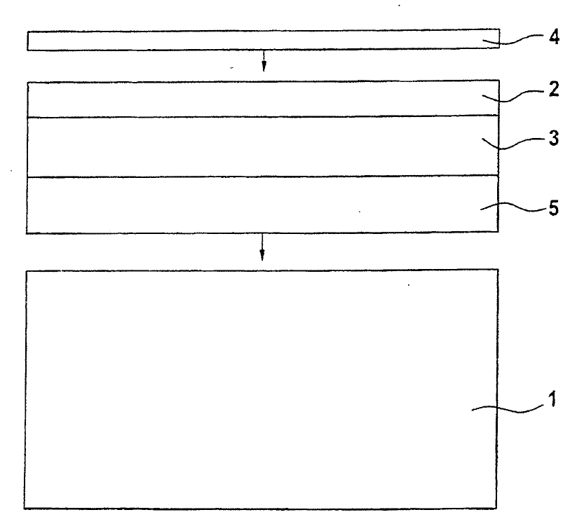

The invention relates to multilayer composite products used especially for making floorcoverings or wallcoverings, and also for the interior furnishing of vehicles for transporting people, such as motor vehicles, railway carriages, ship cabins and aircraft cockpits.

The invention relates more especially to multilayer products comprising a polymer substrate and a wear layer containing copolymer of ionomeric type, and also to a process for manufacturing such multilayer products.

For the manufacture of floor and wall coverings, and also furnishings for vehicle interiors, multilayer products in laminar form are usually used, comprising a support or substrate layer and a superficial wear layer. The support layer generally has a decorative face on which the wear layer is applied. The wear layer serves to protect the decorative face of the substrate. It is usually transparent and should have adequate resistance to mechanical attack (impacts, abrasion) and to chemical attack under the normal conditions of use. These functions of multilayer products condition the choice of materials used for manufacturing them. This choice is also conditioned by health, environmental and implementation considerations. In particular, the multilayer products must be able to withstand implementation by rolling or thermoforming, which involves the use of thermoplastic polymers. The adhesion of the superposed layers must be sufficient to ensure cohesion of the multilayer product in the applications for which it is intended. It is also desirable to select materials that allow recycling of the spent multilayer products. Moreover, the exudation of volatile materials (such as plasticizers) during the use of these multilayer products should be avoided or limited.

Polyvinyl chloride (PVC) has been used for a long time for the manufacture of multilayer products in laminar form for making carpets, wallcoverings or vehicle interior furnishings. However, considerations linked to environmental protection argue strongly in favor of replacement of polyvinyl chloride with chlorine-free polymers or copolymers. The choice has quite naturally turned to olefinic polymers and copolymers, especially ethylene and propylene polymers and copolymers, given their relatively low cost and their good chemical and thermal properties.

However, olefinic polymers present various drawbacks. In particular, in order to achieve sufficient adhesion of the wear layer to the substrate, it is generally necessary to use highly crystalline polymers, which greatly reduces the transparency of the surface wear layer. Moreover, sufficient cohesion of the multilayer product is incompatible with the presence of mineral fillers in the support or substrate layer. The impossibility of filling the support layer with mineral materials is a major drawback as regards the mechanical strength properties of the multilayer product and moreover has a negative impact on its cost.

In document EP-B-0 930 156, an attempt is made to overcome this drawback by incorporating into the substrate a mineral filler selected from calcium sulfate, magnesium carbonate, fumed silica, aluminum hydrate, kaolin and barium sulfate, and by using for the wear layer a copolymer of the ionomeric type.

Although they combine desired properties for the multilayer products (especially good cohesion, good mechanical properties and a transparent surface layer), these known products are not designed to be manufactured by the technique of extrusion blow-molding. Specifically, with these known products, it is impossible, during the blow-molding operation, to obtain a stable bubble once the thickness of the superposed layers exceeds 40 to 50 μm, which is largely insufficient, especially as regards the wear layer containing the ionomer.

The invention is directed toward adapting the known product described in document EP-B-0 930 156 to a manufacture via the extrusion blow-molding technique, while at the same time conserving its good physical and chemical properties, especially its internal cohesion, the adhesion of the layers of which it is composed, its thermal properties, its mechanical wear strength and impact strength, its resistance to chemical attack and the transparency of its surface wear layer.

Consequently, the invention relates to multilayer products comprising, on a polymer substrate, a wear layer made of polymer of the ionomeric type, said products being characterized by the presence, between the substrate and the wear layer, of an intermediate layer of an olefinic polymer containing a metallocene.

The substrate of the multilayer products has the function of acting as a mechanical support. It may include a decorative pattern on one of its faces. It essentially comprises a polymer compound, which is generally olefinic. The polymer compound may be an olefinic homopolymer or copolymer.

In the description hereinbelow, for the purpose of simplicity, the term “polymer” will denote either a homopolymer or a copolymer.

The olefinic polymer forming part of the constitution of the substrate of the products according to the invention may be selected from polymers of ethylene, propylene and butylene. It may be a homopolymer or a copolymer, for example a copolymer of ethylene and propylene or a copolymer of ethylene and butylene. Standard polyethylenes and/or metallocene polyethylenes are preferred. High-density polyethylenes (HDPE), low-density polyethylenes (LDPE), linear low-density polyethylenes (LLDPE) and linear very low-density polyethylenes (VLDPE) are especially recommended.

In the multilayer products according to the invention, the olefinic polymer of the substrate is substantially free of ionic bonds.

The term “substantially free of ionic bonds” means that the number of carboxylic acid groups in the polymer does not exceed 25% and is, for example, between 0 and 15%.

The polymer of the substrate of the products according to the invention may comprise mineral fillers intended to give it particular mechanical properties. Mineral fillers that may be used in the substrate include calcium carbonate, magnesium carbonate, calcium sulfate, barium carbonate, barium sulfate, kaolin, fumed silica, aluminum hydrate and expanded graphite.

The function of the wear layer is to protect the substrate against mechanical and chemical attack in the applications for which the multilayer products according to the invention are intended. It comprises a polymer of the ionomeric type.

The polymers of the ionomeric type in the wear layer are well known in the art. They are copolymers containing ionic bonds, comprising a hydrocarbon-based chain containing carboxylic acid side groups partially or totally neutralized with cations. The hydrocarbon-based chain is an olefinic chain, for example an ethylenic chain. The carboxylic acid groups comprise, for example, α and β ethylenically unsaturated carboxylic acids and the cations may comprise, for example, metallic cations or amine cations. Further information regarding copolymers of the ionomeric type is especially available from documents FR-A-1 430 478, U.S. Pat. No. 3,264,272 and U.S. Pat. No. 3,322,734 and also from the article “The structure and properties of ionomers”—W. J. Machnight and T. R. Earnest Jr., published in Macromolecules Reviews, Vol. 16, pages 41-122 (1981).

The optimum thickness of the wear layer depends on various parameters, such as the material used for said wear layer and the applications for which the multilayer products according to the invention are intended. In practice, good results are generally obtained with wear layers at least 30 μm (preferably 60 μm) thick, thicknesses of between 40 and 300 μm being especially advantageous.

As a variant, the wear layer may be coated with a polyurethane surface layer to enhance the abrasion wear strength.

According to the invention, an intermediate layer of an olefinic polymer containing a metallocene is placed between the substrate and the wear layer. Advantageously, this intermediate layer is transparent.

The olefinic polymer of the intermediate layer may be either a homopolymer or a copolymer. Homopolymers are particularly suitable for use. Ethylene homopolymers are preferred, and, among these, low-density polyethylenes (LDPE) are especially recommended.

In the multilayer products according to the invention, the intermediate layer may comprise a single olefinic polymer or a blend of different olefinic polymers, in accordance with the above definition. In the text hereinbelow, unless otherwise mentioned, the expression “olefinic polymer of the intermediate layer” will denote either a single olefinic polymer or a blend of at least two different olefinic polymers, the polymer or each polymer possibly being either a homopolymer or a copolymer.

In the multilayer products according to the invention, the olefinic polymer of the intermediate layer also has the function of allowing the manufacture of multilayer products via the extrusion blow-molding technique or of improving its performance. It more particularly makes it possible, in the implementation of this extrusion blow-molding technique, to stabilize large bubbles or sufficient thickness.

The term “metallocene” means polyolefins or, respectively, polyethylenes, manufactured using metallocene catalysts that are well known in the art.

In the products according to the invention, the metallocene is advantageously selected from polyolefins and more particularly from polyethylenes with a density of less than 0.900.

The multilayer products according to the invention may comprise a single metallocene or a blend of different metallocenes, in accordance with the above definition. In the text hereinbelow, unless otherwise mentioned, the term “metallocene” will denote either a single metallocene or a blend of at least two different metallocenes.

In the multilayer products according to the invention, the function of the metallocene is to achieve an effective and sufficient adhesion of the intermediate layer to the wear layer and to the substrate. To this end, it is present in the intermediate layer in an amount preferably greater than 1 part (more preferably 5 parts) by weight per 100 parts by weight of the olefinic polymer. At least 5 parts (preferably at least 15 parts) by weight of metallocene per 100 parts by weight of the olefinic polymer are advantageously used.

However, an exaggerated amount of metallocene should be avoided, to avoid the risk of harming the stability of the bubble when the products according to the invention are manufactured via the extrusion blow-molding technique. Generally, it is recommended that the amount of metallocene in the olefinic polymer of the intermediate layer should not exceed 40 parts by weight per 100 parts by weight of polymer and should preferably be less than 30 parts by weight per 100 parts by weight of the olefinic polymer. Amounts of metallocene of from 5 to 20 (preferably from 8 to 15) parts by weight per 100 parts by weight of olefinic polymer are generally suitable.

In the products according to the invention, the metallocene may be introduced into the olefinic polymer of the intermediate layer in the form of a filler.

In one particular embodiment of the multilayer products according to the invention, an additional layer of low-density polyethylene (LDPE) is placed between the substrate and the abovementioned intermediate layer. This additional layer may also contain fatty acids and/or silica. These additives improve, on the one hand, the adhesion of the intermediate layer to the substrate and, on the other hand, facilitate the extrusion by blow-molding.

The polymers forming part of the constitution of the multilayer products according to the invention may optionally contain additives commonly present in multilayer products to give them particular properties or to facilitate their implementation, for example lubricants, plasticizers, pigments or foaming agents.

The multilayer products according to the invention combine a mixture of advantageous properties, which were previously considered as being incompatible, in particular a high abrasion wear strength and high resistance to mechanical attack, high resistance to chemical attack and great cohesion.

The multilayer products according to the invention are especially suitable for manufacture via the extrusion blow-molding technique.

The invention consequently also relates to a process for manufacturing a multilayer product in accordance with the invention, according to which a parison comprising an inner layer of an olefinic polymer containing a metallocene and an outer layer comprising a polymer of the ionomeric type is extruded, the parison is subjected to blow-molding and the bubble collected from the blow-molding is crushed.

This process makes it possible to manufacture a multilayer film comprising a wear layer comprising a polymer of the ionomeric type and a layer made of an olefinic polymer containing a metallocene.

According to a first advantageous embodiment, an outer layer made of polyolefin, preferably an outer layer made of low-density polyethylene, is extruded on to the intermediate layer of an olefinic polymer containing a metallocene. The film thus obtained comprises an outer layer of a product that serves to form the wear layer of the multilayer product, an intermediate layer of an olefinic polymer comprising, where appropriate, additives such as fatty acids and/or silica, and a layer made of an olefinic polymer comprising a metallocene.

More detailed information regarding these layers and their respective constituents may consequently be found hereinabove.

The extrusion and blow-molding techniques used in the process according to the invention are well known in processes for processing plastics. Any known suitable technique may be used to crush the bubble collected from the blow-molding operation. A technique of rolling between metallic rolls is advantageously used. After crushing the bubble, the film obtained is separated and is then fixed (for example by lining or by rolling) onto a support to form the multilayer product described above.

In one advantageous embodiment of the process according to the invention, the blow-molding of the parison is regulated such that the circumference of the bubble measures at least 8 m and its thickness is from 150 to 250 μm.

The process according to the invention makes it possible to obtain large multilayer products, whose width may reach several meters and thickness several tens of microns. More especially, the process according to the invention allows the manufacture of multilayer products in strips whose width exceeds 4 m (and may even reach 8 m and more) and whose thickness exceeds 60 μm and may even reach 200 μm and more.

The products according to the invention find a number of applications. They find applications in the construction industry, and for making rugs, carpets and wallcoverings. They are also used in the motor vehicle, aviation, marine and railway industries, for the manufacture of carpets and also for covering the walls of compartments, cockpits and vehicle cabins.

A subject of the invention is consequently also the use of products in accordance with the invention for the manufacture of floor or wall coverings and also for covering the walls of vehicle compartments, especially of vehicles intended for transporting people.

The description that follows of the single FIGURE of the attached drawing illustrates one particular embodiment of the products according to the invention.

The product represented schematically in the FIGURE comprises, in accordance with the invention, a substrate 1, a wear layer 2 and an intermediate layer 3.

The substrate 1 that constitutes the printed, filled support, with or without flakes, consists of a low-density polyethylene layer, containing a mineral filler, for example calcium sulfate, expanded graphite or magnesium carbonate.

The wear layer 2 comprises an ethylenic polymer of the ionomeric type.

The intermediate layer 3 is formed from low-density polyethylene (LDPE) containing a metallocene.

A surface layer 4 made of polyurethane is applied to the wear layer 1 and an additional layer 5 made of low-density polyethylene (LDPE) containing, where appropriate, additives such as fatty acids and/or silica is placed between the substrate 1 and the intermediate layer 3.

1. A multilayer product comprising:
a polymer substrate,
a wear layer made of polymer of an ionomeric type, and,
between the substrate and the wear layer, an intermediate layer of an olefinic polymer containing from 1 to 40 parts by weight of a metallocene per 100 parts by weight of the olefinic polymer.

2. The product according to claim 1, wherein the polymer substrate and the polymer of the ionomeric type comprise olefinic polymers.

3. The product according to claim 2, wherein the olefinic polymers of the substrate and of the intermediate layer comprise low-density polyethylene.

4. The product according to clam 1, wherein the intermediate layer contains from 5 to 30 parts by weight of metallocene per 100 parts by weight of the olefinic polymer.

5. The product according to claim 4, wherein the intermediate layer contains from 8 to 15 parts by weight of metallocene per 100 parts by weight of the olefinic polymer.

6. The product according to claim 1, further comprising an additional layer of low-density ethylene polyolefin between the substrate and the intermediate layer.

7. The product according to claim 6, wherein the additional layer comprises low-density polyethylene and, where appropriate, one or more additives chosen from the group consisting of fatty acids and silica.

8. The product according to any one of claim 1, further comprising a surface layer made of polyurethane on the wear layer.

9. A process for manufacturing a multilayer product comprising:
extruding a parison comprising a layer of an olefinic polymer containing a metallocene and an outer layer made of polymer of an ionomeric type wherein the parison is extruded by blow-molding to form a bubble,
crushing the bubble collected from the blow-molding extrusion to obtain a doubled film,
separating the doubled film to obtain two separate multilayer films, and
fixing one of the films onto a substrate.

10. The process according to claim 9, wherein the outer layer made of polyolefin is extruded onto an intermediate layer of an olefinic polymer containing a metallocene.

11. The process according to claim 9, wherein the blow-molding of the parison is regulated such that a circumference of the bubble measures at least 8 m and a thickness is from 150 to 250 μm.

12. The process according to claim 9 further comprising applying the product as a floor or wall coverings.

13. The process according to claim 10, wherein the outer layer is made of a low density polyethylene.

14. A multilayer product comprising:
a substrate;
a wear layer; and
an intermediate layer disposed between the substrate and the wear layer;
wherein, the intermediate layer comprises an olefinic polymer containing from 1 to 40 parts by weight of a metallocene per 100 parts by weight of the olefinic polymer.
